(19) United States
(12) Patent Application Publication
(10) Pub. No.: US 2018/0335198 A1
(43) Pub. Date: Nov. 22, 2018

(54) Light Distribution System of an LED Lamp

(71) Applicants: Wanjiong Lin, Ningbo (CN); Self Electronics Co., Ltd., Ningbo (CN); Self electronics USA Corporation, Norcross, GA (US)

(72) Inventors: Zuping He, Ningbo (CN); Xiaoyun Liu, Ningbo (CN); Fawei Zhang, Ningbo (CN)

(73) Assignees: Wanjiong Lin; Self Electronics Co., Ltd.; Self Electronics USA Corp.

(21) Appl. No.: 15/971,866

(22) Filed: May 4, 2018

(30) Foreign Application Priority Data
May 18, 2017 (CN) 201710352808.X

(51) Int. Cl. F21V 13/04; F21V 7/00; F21V 5/04

(52) U.S. Cl. CPC F21V 13/04; F21Y 2115/10; F21V 5/04; F21V 7/0008

(57) ABSTRACT

A light distribution system of an LED lamp comprises an illuminated plane, a light source module, and a reflector. The illuminated plane comprises a vertical direction. The light source module comprises a lens, and the lens comprises an optical axis, and a light exit surface. The light exit surface comprises a first contour line and a second contour line with the optical axis as an axis of symmetry. In the cross section along the vertical direction and the optical axis, the reflected light from the first contour line is emitted to one side of the optical axis after being reflected by the reflector. The reflected light from the second contour is reflected by the reflection plate and then emitted to both sides of the optical axis. The reflected light of the reflection plate is directed to the illuminated plane. The present invention uses the lens, the reflector and the cooperation function between the lens and the reflector so that the objects in the upper layer of the illuminated plane and the objects in the lower layer have the same illumination thereby greatly improve the utility of the user Light experience and increase the user's shopping desires.

### CROSS-REFERENCE TO A RELATED APPLICATION

This application claims priority to a Chinese Patent Application No. CN 201710352808.X, filed on May 18, 2017.

### FIELD OF THE TECHNOLOGY

The present invention relates to the lighting equipment field, with particular emphasis on a light distribution system of an LED lamp.

### BACKGROUND

In ordinary daily life, all kinds of lighting apparatus can be seen everywhere, such as fluorescent lamps, street lamps, table lamps, artistic lamps and so on. In the above-described lighting apparatus, the tungsten bulb is traditionally used as a light-emitting light source. In recent years, due to the ever-changing technology, light-emitting diode (LED) has been used as a light source. Moreover, in addition to lighting apparatus, for the general traffic signs, billboards, headlights etc., light-emitting diode has also been used as a light source. The light-emitting diode as a light source has the advantages of energy-saving and greater brightness. Therefore, it has been gradually common.

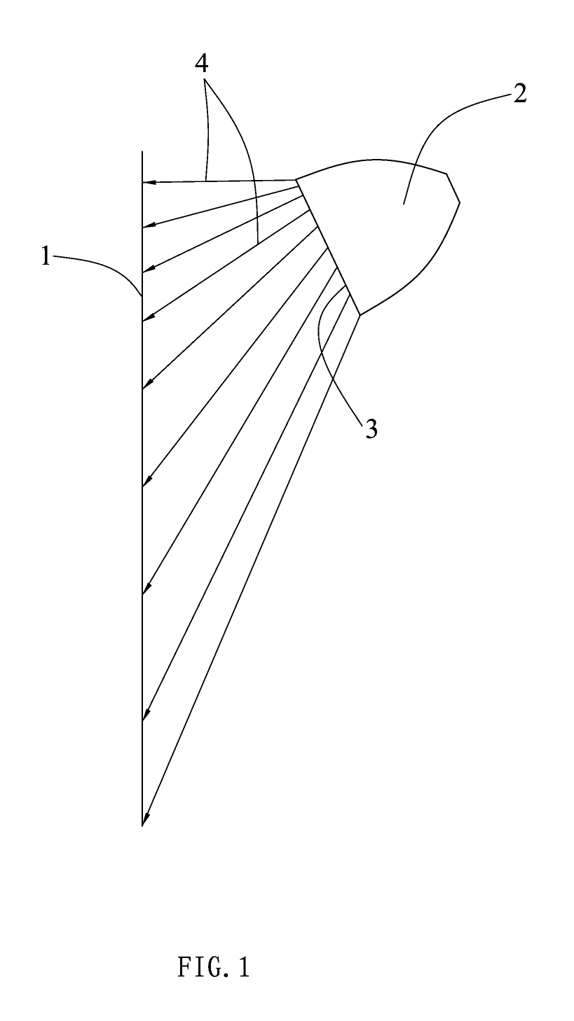

As shown in FIG. 1, it is a schematic diagram of an optical path of a lighting system using LEDs as a light source in the prior art. The lighting system comprises an illuminated surface 1 and an LED light source 2 disposed on a side of the illuminated surface 1. The LED light source 2 comprises a light-emitting surface 3, which emits numerous light rays 4 and illuminates the illuminated surface 1. It is conceivable that no matter where the LED light source 2 is placed on the illuminated surface 1, a part of the light 4 emitted by the light emitting surface 3 will certainly be emitted toward the proximal end of the illuminated surface 1, while the other part will certainly emit toward the distal end of the illuminated surface 1. It is because of the above unavoidable light irradiation structure that the light emitted toward the proximal end of the illuminated surface 1 will be attenuated relative to the light emitted toward the distal end of the illuminated surface 1. Regardless of whether the light is directed to the proximal end or the distal end, the light has the same initial illumination value, so the brightness of the emitted surface 1 differs from the distance between the LED light source 2 and the illuminated surface 1.

For some occasions, such as exhibition halls, exhibitions, or some shopping malls of lighting occasions, due to uneven lighting effects, this non-uniform lighting effect will reduce the visual effects displayed by the display items to visitors or purchase, thereby reduce the visual impression of the quality of items displayed.

### SUMMARY OF THE INVENTION

Therefore, it is necessary to provide a light distribution system of an LED lamp which can uniform illumination.

A light distribution system of an LED lamp, comprising: an illuminated plane, a light source module disposed on one side of the illuminated plane, and a reflector disposed in the light-out direction of the light source module; the illuminated plane comprising a vertical direction, the light source module comprising a lens, the light-out direction of the lens being away from the illuminated plane, the lens comprising an optical axis perpendicular to a vertical direction and a light-out surface that converges the incident light and comprises a first contour line that is symmetric with respect to the optical axis in a cross section along the vertical direction and a second contour line that is symmetric with respect to the optical axis in a cross section along the optical axis and perpendicular to the vertical direction, a light-out angle of the second contour line being greater than that of the first contour line, a plane where the first contour line is located forming the light-out surface by scanning along the second contour line, the reflector being spaced apart from the lens; on a cross section formed by the vertical direction and the optical axis, a reflected light from the first contour line being emitted to one side of the optical axis after being reflected by the reflector; on a cross section formed by the optical axis and the direction perpendicular to the vertical direction, a reflected light from the second contour line being emitted to two sides of the optical axis after being reflected by the reflector, the reflected light of the reflector being emitted to the illuminated plane.

Further, the light-out surface is formed by the second contour line scanning the first contour line

Further, the lens further comprises a light incident surface perpendicular to the optical axis, the light incident surface is defined by the line of the two end points of the first contour line scanning along the line of the two ends of the second contour line.

Further, the lens further comprises a supporting portion extending from the light incident surface, and the supporting portion has a accommodating cavity.

Further, the light source module further comprises an LED chip, a center of the LED chip is located on the optical axis, and the LED chip has a light-emitting surface, the light-out surface is spaced apart from the light incident surface.

Further, a distance between the light-emitting surface and the light incident surface is equal to a thickness of the supporting portion along the optical axis.

Further, on a cross section formed by the vertical direction and the optical axis, a line between the upper edge of the illuminated plane and the upper edge of the reflector is tangent to the first contour line.

Further, on a cross section formed by the vertical direction and the optical axis, the angle between the upper and the lower edge of the reflector and the center of the LED chip respectively is greater than light-out angle of the first contour line.

Further, on a cross section formed by the vertical direction and the optical axis, the angle between the optical axis and the reflector is an acute angle.

Further, the optical axis is perpendicular to the illuminated plane.

Compared with the prior art, the present invention uses the lens, the reflector and the cooperation function between the lens and the reflector so that the light reflected by the reflector can be uniformly emitted on the illuminated plane along the vertical direction of the illuminated plane and the luminance in the vertical direction along the illuminated plane is substantially consistent. The objects in the upper layer of the illuminated plane and the objects in the lower layer have the same illumination thereby greatly improve the utility of the user Light experience and increase the user's shopping desires.

### DETAILED DESCRIPTION OF THE DRAWINGS

The drawings described herein are intended to promote a further understanding of the present invention, as follows:

FIG. 1 is a schematic view of an optical path of a lamp lighting system in the prior art.

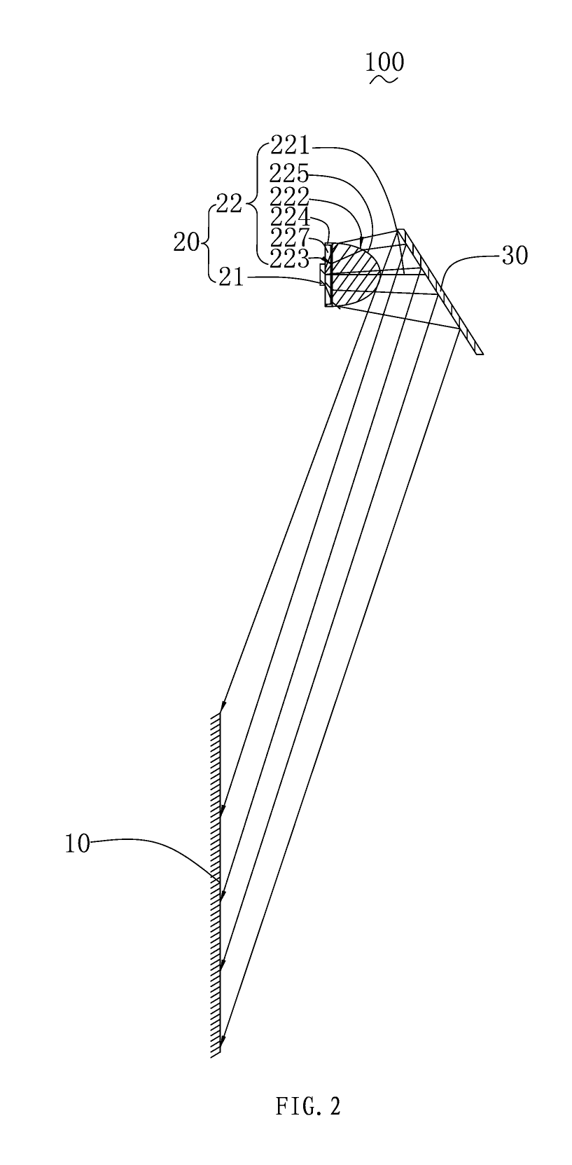

FIG. 2 is a schematic view and optical path schematic diagram of a light distribution system of an LED lamp provided by the present invention.

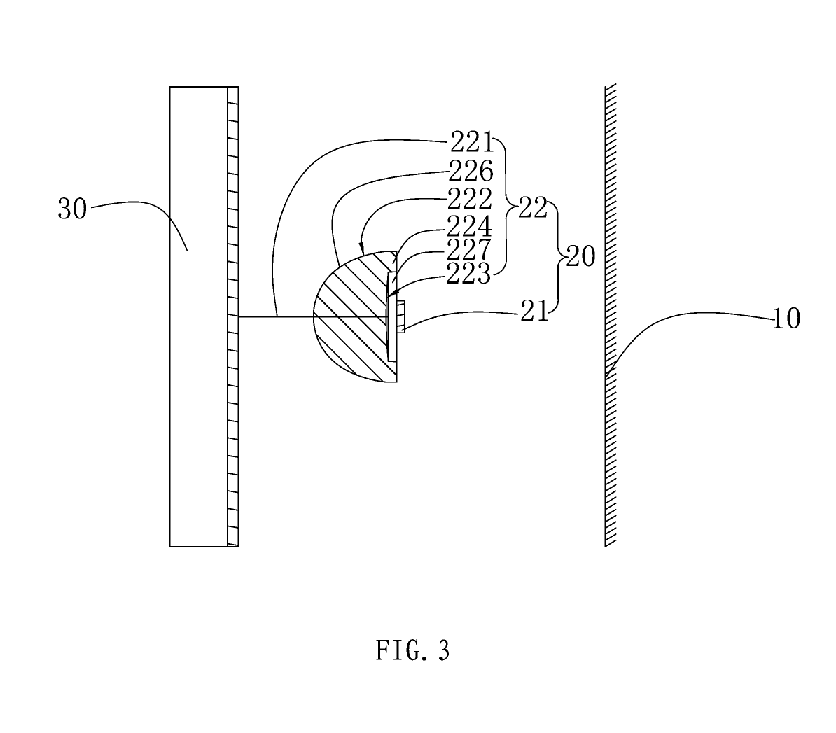

FIG. 3 is a schematic structure view of the light distribution system of the LED lamp in another direction in FIG. 2.

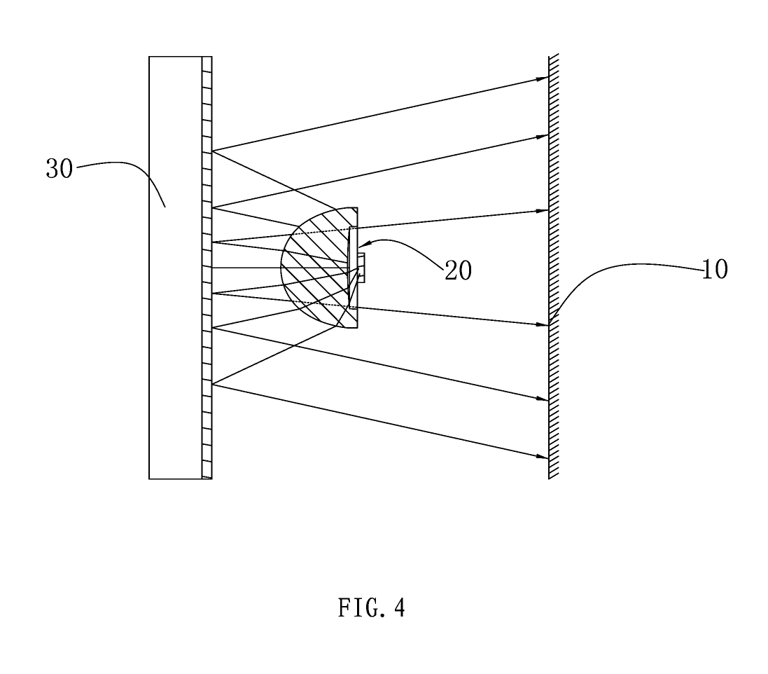

FIG. 4 is a schematic view of the optical path of the light distribution system of the LED lamp in FIG. 3.

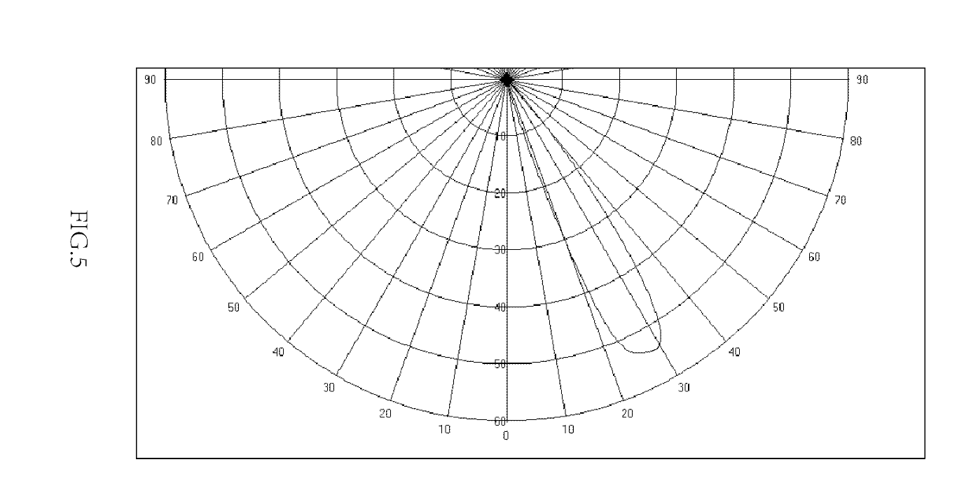

FIG. 5 is a light intensity diagram of the light distribution system of the LED lamp of FIG. 1.

### DESCRIPTION OF THE PREFERRED EMBODIMENTS

The present application is illustrated by way of the following detailed description based on of the accompanying drawings. It should be noted that illustration to the embodiment in this application is not intended to limit the invention.

Please referring to FIG. 2 to FIG. 4, FIG. 2 is a schematic view and optical path schematic diagram of a light distribution system 100 of an LED lamp provided by the present invention. The light distribution system 100 of an LED lamp comprises an illuminated plane 10, a light source module 20 disposed on one side of the illuminated plane, and a reflector 30 disposed in the light-emitting direction of the light source module 20. Since the present invention focuses on the structure and the light distribution of the light distribution system, the illuminated plane 10, the light source module 20 and the reflector 30 are all schematic diagrams. It is conceivable that the LED lamp further comprises other functional modules such as a power module, a mechanical module of the lamp, such as a lamp housing, a lampshade and the like for assembling the structural components of the light source module 20, and a structure component for assembling the reflector. However, these structure components should be well known to those skilled in the art and are not the focus of the present invention. Therefore, the above structure components in the present invention are neither described in detail not shown in the drawings.

The illuminated plane 10 may be a shelf in a warehouse or shopping mall, a wall in a museum or an exhibition hall, or a front row of goods such as a freezer. Although the aforementioned light environment can't be an absolute plane, in the present invention, for the sake of simplification of description, in the actual optical design, the aforementioned light environment is simulated as a single plane for light distribution design. Therefore, in the drawings, only one line is used instead of the light environment. In optical design, a reference is necessarily required to configure the propagation path of the light, so in the present embodiment, the illuminated plane 10 comprises a vertical direction. The vertical direction of the illuminated plane 10 serves as one dimension of the light distribution system.

The light source module 20 comprises an LED chip 21 and a lens 22 disposed in the light-out direction of the LED chip 21. It is understandable that the light source module 20 further comprises other functional modules such as a heat dissipation device disposed on the LED chip 21, a lamp holder structure for fixing the lens 22, and a light source for providing power to the LED chip 21, etc., which are known to those skilled in the art, which need not be described in detail herein. In order to simplify the explanation, only the LED chip 21 and the lens 22 are shown in FIG. 1. The LED chip 21 is a solid-state semiconductor device capable of converting electrical energy into visible light, which can directly convert electricity into light energy. The related technologies on LEDs are well-known to those skilled in the art and will not be repeated here.

The lens 22 comprises an optical axis 221 perpendicular to the vertical direction of the illuminated plane 10, a light-out surface 222, a light incident surface 223, and a supporting portion 224 extending from the light incident surface 223. The lens 22 can be made of transparent material or a non-lens material with a certain light transmittance. In this embodiment, the lens 22 is made of transparent material.

Each lens comprises at least one optical axis. In this embodiment, the lens 22 comprises only one optical axis 221. The optical axis 221 is used to set a light source, ie, an LED chip 21, and it is also well known that the optical axis 221 is also a guide for optical path design. The optical axis 221 is perpendicular to the vertical direction of the illuminated plane 10 and thus the direction of the optical axis 221 becomes another dimension of the light distribution system so that the vertical direction of the illuminated plane 10 and a direction of the optical axis 221 form a two-dimensional plane. It is well-known that the direction is a vector. Therefore, if the direction of the optical axis 221 along the light-out direction of the lens 22 is the positive direction, the negative direction of the optical axis 221 is opposite to the light-out direction of the lens 22. The positive direction of the optical axis 221 is away from the illuminated plane 10, that is, the light-out direction of the lens 22 is away from the illuminated plane 10.

Referring to FIG. 2 and FIG. 3, the light-out surface 222 converges the incident light and comprises a first contour line 225 that is symmetric with respect to the optical axis and a second contour line 226 that is symmetric with respect to the optical axis 221 in a cross section along the optical axis 221 and perpendicular to the vertical direction. A plane where the first contour line is located forms the light-out surface by scanning along the second contour line, the reflector being spaced apart from the lens. Of course, it can be understood that the light-out surface is formed by the second contour line scanning the first contour line. The “scanning” should be a modern technical term that is used in the fields of electronic projection technology, 3D printing technology, graphics technology and the like. In the present invention, the “scanning” refers to scanning in a drawing technique, such as “scanning” in PRO/E, which refers to an entity formed by a cross section along a curve. In order to configure the light according to the needs, the light-out angle of the second contour line 226 is greater than that of the first contour line 225. It is well-known that the light-out angle of a light-out surface in a certain cross-section will determine its illumination range. Therefore, when the light-out angle of the second contour line 226 is greater than the light exit angle of the first contour line 225, the irradiation range of the light-out surface 222 in the vertical cross section perpendicular to the illuminated surface 10 is larger than the irradiation area of the light-out surface 222 in the vertical cross section parallel to the illuminated surface 10.

The light incident surface 223 may be a plane for receiving the emergent light from the LED chip 21. The formation of the light incident surface 223 is also formed simultaneously with the formation of the light-out surface 222. The light incident surface is defined by the line of the two end points of the first contour line 225 scanning along the line of the two ends of the second contour line 226. And it can be understood that the light incident surface 223 is defined by the line of the two end points of the second contour line 226 scanning along the line of the two ends of the first contour line 225. Since both the first and second contour lines 225 and 226 are symmetric with respect to the optical axis 221, no matter whether the first contour line 225 is a cross section or the second contour line 226 is a cross section, the light incident surface 223 will be a plane. According to the above-mentioned scan forming theory, the light incident surface 223 should be perpendicular to the optical axis 221.

The supporting portion 224 is configured to dispose the lens 22 and extend from the light incident surface 223 along the negative direction of the optical axis 221. Since the light-emitting surface of the LED chip 21 can't be directly attached to the light incident surface 223 but spaced apart from the light incident surface 223, the light of the LED chip 21 should be projected at a distance that is in the scope of a circle whose diameter is formed by the connecting lines of the two end points of the first contour 225. Since the length of the connecting line of the two end points of the second contour line 226 is greater than the length of the connecting line of the two end points of the first contour line 225, the supporting portion 224 is disposed at a position that is in the outside of a circle whose diameter is formed by the connecting lines of the two end points of the first contour 225, thereby forming a accommodating cavity 227. The light of the LED chip 21 completely enters into the accommodating cavity 227. The thickness of the supporting portion 224 may be the same as the distance between the light-emitting surface of the LED chip 21 and the light incident surface 223.

The reflector 30 is disposed in the light-out direction of the light source module 20 and spaced apart from the lens 22. The structure of the reflector 30 itself should be well known to those skilled in the art. The reflector 30 is usually made of a transparent plastic plate with a reflective film attached thereto.

The light emitted from the first contour line 225 is emitted to a side of the optical axis 221 after being reflected by the reflector 30 on the cross section along or parallel to the illuminated plane 10 and the optical axis 221. On a cross section formed by the direction along or parallel to the illuminated plane 10 and the optical axis 221, a reflected light from the first contour line 225 is emitted to one side of the optical axis after being reflected by the reflector 30; on a cross section formed by the optical axis and the direction perpendicular to the vertical direction, a reflected light from the second contour line 226 is emitted to two sides of the optical axis after being reflected by the reflector 30. The reflected light of the reflector 30 is emitted to the illuminated plane 10. Due to the action of light on the first contour line 225 and the reflection effect of the reflector 30, On a cross section formed by the direction along or parallel to the illuminated plane 10 and the optical axis 221, the light of one side of the optical axis 221 is reflected to the position away from the light source module 20, the light of the other side of the optical axis 221 with weak light intensity is reflected to the position close to the light source module 20, while the light with strong light intensity is reflected to the position away from the light source module 20, as shown in FIG. 5, so as to compensate for the loss of light due to the light away from the light source module 20.

On a cross section formed by the direction along or parallel to the optical axis 221 and the direction perpendicular to the vertical direction of the illuminated plane 10, a reflected light from the two sides of the second contour line 226 is emitted to two sides of the optical axis, so it doesn't cause less light on one side and more on the other side. The illumination intensity near the light source module 20 and away from the light source module 20 can be substantially the same. Here, it is necessary to explain the meaning of “substantially the same”. This means that although illumination value may not be exactly the same because the illumination instrument measures the two sides of the illuminated surface 10 far or near the light source module 20, but it is hard to perceive this difference by the naked eye, so that the lighting effect of the illuminated plane 10 is consistent for the human's vision. When the reflector 30 is disposed, in order to make the volume of the LED lamp smaller and reasonable, on a cross section formed by the vertical direction and the optical axis 221, a line between the upper edge of the illuminated plane 10 and the upper edge of the reflector 30 is tangent to the first contour line, while the angle between the optical axis 221 and the reflector 30 is an acute angle. On a cross section formed by the vertical direction and the optical axis 221, the angle between the upper and the lower edge of the reflector 30 and the center of the LED chip 21 respectively is greater than light-out angle of the first contour line 225 so that the reflector 30 can receive all the light-emitting rays of the first contour line 225.

Compared with the prior art, the present invention uses the lens 22, the reflector 30 and the cooperation function between the lens 22 and the reflector 30 so that the light reflected by the reflector 30 can be uniformly emitted on the illuminated plane 10 along the vertical direction of the illuminated plane 10 and the luminance in the vertical direction along the illuminated plane 10 is substantially consistent. The objects in the upper layer of the illuminated plane 10 and the objects in the lower layer have the same illumination thereby greatly improve the utility of the user Light experience and increase the user's shopping desires.

The above disclosure has been described by way of example and in terms of exemplary embodiment, and it is to be understood that the disclosure is not limited thereto. Rather, any modifications, equivalent alternatives or improvement etc. within the spirit of the invention are encompassed within the scope of the invention as set forth in the appended claims.

What is claimed is:

1. A light distribution system of an LED lamp, comprising: an illuminated plane, a light source module disposed on one side of the illuminated plane, and a reflector disposed in the light-out direction of the light source module; the illuminated plane comprising a vertical direction, the light source module comprising a lens, the light-out direction of the lens being away from the illuminated plane, the lens comprising an optical axis perpendicular to a vertical direction and a light-out surface that converges the incident light and comprises a first contour line that is symmetric with respect to the optical axis in a cross section along the vertical direction and a second contour line that is symmetric with respect to the optical axis in a cross section along the optical axis and perpendicular to the vertical direction, a light-out angle of the second contour line being greater than that of the first contour line, a plane where the first contour line is located forming the light-out surface by scanning along the second contour line, the reflector being spaced apart from the lens;
on a cross section formed by the vertical direction and the optical axis, a reflected light from the first contour line being emitted to one side of the optical axis after being reflected by the reflector;
on a cross section formed by the optical axis and the direction perpendicular to the vertical direction, a reflected light from the second contour line being emitted to two sides of the optical axis after being reflected by the reflector, the reflected light of the reflector being emitted to the illuminated plane.

2. The light distribution system of an LED lamp as claimed in claim 1, wherein the light-out surface is formed by the second contour line scanning the first contour line

3. The light distribution system of an LED lamp as claimed in claim 1, wherein the lens further comprises a light incident surface perpendicular to the optical axis, the light incident surface is defined by the line of the two end points of the first contour line scanning along the line of the two ends of the second contour line.

4. The light distribution system of an LED lamp as claimed in claim 3, wherein the lens further comprises a supporting portion extending from the light incident surface, and the supporting portion has a accommodating cavity.

5. The light distribution system of an LED lamp as claimed in claim 4, wherein the light source module further comprises an LED chip, a center of the LED chip is located on the optical axis, and the LED chip has a light-emitting surface, the light-out surface is spaced apart from the light incident surface.

6. The light distribution system of an LED lamp as claimed in claim 5, wherein a distance between the light-emitting surface and the light incident surface is equal to a thickness of the supporting portion along the optical axis.

7. The light distribution system of an LED lamp as claimed in claim 1, wherein on a cross section formed by the vertical direction and the optical axis, a line between the upper edge of the illuminated plane and the upper edge of the reflector is tangent to the first contour line.

8. The light distribution system of an LED lamp as claimed in claim 1, wherein on a cross section formed by the vertical direction and the optical axis, the angle between the upper and the lower edge of the reflector and the center of the LED chip respectively is greater than light-out angle of the first contour line.

9. The light distribution system of an LED lamp as claimed in claim 1, wherein on a cross section formed by the vertical direction and the optical axis, the angle between the optical axis and the reflector is an acute angle.

10. The light distribution system of an LED lamp as claimed in claim 1, wherein the optical axis is perpendicular to the illuminated plane.
